(19) United States
(12) Patent Application Publication
(10) Pub. No.: US 2025/0023063 A1
(43) Pub. Date: Jan. 16, 2025

(54) METHOD OF MANUFACTURING BIPOLAR PLATES

(71) Applicant: MAGNA INTERNATIONAL INC., Aurora (CA)

(72) Inventors: Darren WOMACK, LaSalle (CA); Manoj Kumar SURYADEVARA, Wiener Neustadt (AT)

(21) Appl. No.: 18/768,140

(22) Filed: Jul. 10, 2024

Related U.S. Application Data
(60) Provisional application No. 63/526,030, filed on Jul. 11, 2023.

(51) Int. Cl. H01M 8/0254; B21D 13/04; B21H 8/00; H01M 8/0206

(52) U.S. Cl. CPC H01M 8/0254; B21D 13/04; B21H 8/005; H01M 8/0206

(57) ABSTRACT

A method of manufacturing bipolar plates includes passing a metal sheet through at least one tension roller disposed either upstream or downstream to a BPP forming roll to establish a longitudinal tension on the metal sheet as it passes through the BPP forming roll. A first pair of inner and outer lateral tension features are formed along a first side of the metal sheet and a second pair of inner and outer later tension features are formed along a second side of the metal sheet for use in establishing a lateral tension on the metal sheet as it passes through the BPP forming roll. The inner and outer lateral tension features in each of the first and second pairs have varying or different heights to advantageously provide a more consistent application of the lateral tension to the metal sheet.

### CROSS REFERENCE TO RELATED APPLICATION

This U.S. patent application claims the benefit of and priority to U.S. Provisional Patent Application Ser. No. 63/526,030 filed on Jul. 11, 2023 titled “Method of Manufacturing Bipolar Plates,” the entire disclosure of which is hereby incorporated by reference.

### BACKGROUND OF THE INVENTION

### 1. Field of the Invention

The present invention relates to a method of manufacturing bipolar plates for fuel cells.

### 2. Related Art

This section provides background information related to the present disclosure which is not necessarily prior art.

Automobiles are the subject of a continuing effort to move away from internal combustion engines towards electrified vehicles, to reduce their dependency on fuel, improve emissions, and increase fuel efficiency. Fuel cells are an alternative option to full battery electrified vehicles, with bipolar plates (“BPP”) being a key component of these fuel cells. However, the cost of manufacturing bipolar plates is a significant barrier to market implementation of fuel cells. Additionally, present methods for manufacturing bipolar plates, including stamping, hydro-forming, and roll embossed forming, are not suitable for mass scale manufacturing with the higher required throughput rates. These manufacturing methods, especially roll embossed forming, are also prone to a number of manufacturing problems, including wrinkling, spring back or bending of the metal sheet during forming of the bipolar plates.

The prior art methods of manufacturing bipolar plates via roll embossed forming have incorporated and utilized the application of both longitudinal and lateral tension to the metal sheet during the BPP forming process in an attempt to solve these manufacturing problems. One such example is disclosed in DE 10 2021 122 402 A1. These prior art manufacturing methods incorporate at least one tension roller disposed upstream or downstream from a BPP forming roll to apply a longitudinal tension to the metal sheet, and then additionally form and incorporate a single lateral tension feature, such as a nip, extending along both sides of the metal sheet to create a lateral tension in the metal sheet as it passes through the BPP forming roll to form the BPPs. However, use of this single lateral tension feature is not sufficient to consistently establish and maintain the lateral tension during the BPP forming process, and thus still results in wrinkling, spring back or bending of the metal sheet during formation of the bipolar plates.

Accordingly, there is a continuing need for new and improved manufacturing methods for producing bipolar plates in a mass scale with higher throughput rates that provide the sought-after improved quality from the manufactured BPPs.

### SUMMARY OF THE INVENTION

The subject disclosure is directed to the manufacturing of bipolar plates using the application of both longitudinal and lateral tension to the metal sheet during the BPP forming process, in which a plurality of first lateral tension features are formed and extend along a first side of the metal sheet and a plurality of second lateral tension features are formed and extend along a second side of the metal sheet to establish the lateral tension during the BPP forming process. In a preferred arrangement, the plurality of first and second lateral tension features each include a pair of inner and outer lateral tension features defined relative to a longitudinal direction of the metal sheet, in which one of the inner or outer lateral tension features has a height being greater than a height of the other inner or outer lateral tension feature. The use of lateral tension features of varying heights along both sides of the metal sheet provides a more consistent application of lateral tension during the BPP forming process as compared to a single lateral tension feature, which advantageously solves the problems of wrinkling, spring back and bending of the metal sheet during forming of the bipolar plates.

### BRIEF DESCRIPTION OF THE DRAWINGS

These and other advantages of the present disclosure will be more readily understood by reference to the following description in combination with the accompanying drawings wherein:

FIG. 1 is a flowchart illustrating a method of manufacturing bipolar plates which includes forming a first pair of inner and outer lateral tension features along a first side of the metal sheet and a second pair of inner and outer lateral tension features along a second side of the metal sheet via a combined bead and tension roll disposed upstream of a BPP forming roll in accordance with a first arrangement;

FIG. 2 is a flowchart illustrating a method of manufacturing bipolar plates which includes forming a first pair of inner and outer lateral tension features along a first side of the metal sheet and a second pair of inner and outer lateral tension features along a second side of the metal sheet via a pair of bead rollers each attached to a respective end of the BPP forming roll in accordance with a second arrangement;

FIG. 3 is a shared cross-sectional view of the combined bead and tension roll of FIG. 1 and the bead roller of FIG. 2, each taken along the cross-sectional plane 3-3 to illustrate formation of the outer lateral tension feature in each of the first and second pairs of inner and outer lateral tension features having an outer height Hₒ;

FIG. 4 is a shared cross-sectional view of the combined bead and tension roll of FIG. 1 and the bead roller of FIG. 2, each taken along cross-sectional plane 4-4 to illustrate formation of the inner lateral tension feature in each of the first and second pairs of inner and outer lateral tension features having an inner height Hᵢ being less than the outer height Hₒ of the outer lateral tension features;

FIG. 5 is a side view of the combined bead rollers and BPP forming roll of FIG. 2 illustrating the bead rollers having a second axis of rotation A₂ being slightly offset in an upstream direction from a first axis of rotation A₁ of the BPP forming roll to facilitate formation of the first and second pairs of inner and outer lateral tension features by the pair of bead rollers immediately before formation of flow channels for the bipolar plates by the BPP forming roll;

FIG. 6 is a cross-sectional end view of the metal sheet taken along cross-sectional plane 6-6 in FIG. 1 and prior to arriving at the BPP forming roll to illustrate the inner lateral tension features second having an inner height Hᵢ being less than an outer height Hₒ of the outer lateral tension features;

FIG. 7 is a cross-sectional end view of the metal sheet taken along cross-sectional plane 7-7 in FIGS. 1-2 and after leaving the BPP forming roll to illustrate the plurality of channels for the BPP formed in the metal sheet between the first and second pairs of inner and outer lateral tension features;

FIG. 8 is a cross-sectional view of the metal sheet prior to arriving at the BPP forming roll to illustrate an alternative embodiment of the first and second pairs of inner and outer lateral tension features in which the inner and outer lateral features are inverted relative to one another and extend from an opposing top and bottom of the metal sheet to collectively define a cross-sectional S-shape for each pair of inner and outer lateral features;

FIG. 9 is a cross-sectional view of the BPP forming roll of FIG. 1 taken along cross-sectional view 9-9 in FIG. 1 to illustrate the first and second mating features of the BPP forming roll mating with the first and second pairs of inner and outer lateral tension features formed in the metal sheet to establish the lateral tension as the metal sheet passes through the BPP forming roll;

FIG. 10 is a side view of the roll cutter shown in FIGS. 1-2; and

FIG. 11 is a cross-sectional view of the BPP forming roll and the pair of bead rollers attached to each end of the BPP forming roll taken along cross-sectional view 11-11 in FIG. 2 to illustrate an inner and outer forming feature of each bead roller also providing the mating function with the formed first and second pairs of inner and outer lateral tension features to establish the lateral tension as the metal sheet passes through the BPP forming roll.

### DETAILED DESCRIPTION OF THE ENABLING EMBODIMENTS

Example embodiments will now be described more fully with reference to the accompanying drawings. In general, the subject embodiments are directed to method of manufacturing bipolar plates using both lateral and longitudinal tension on the metal sheet during the forming process. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

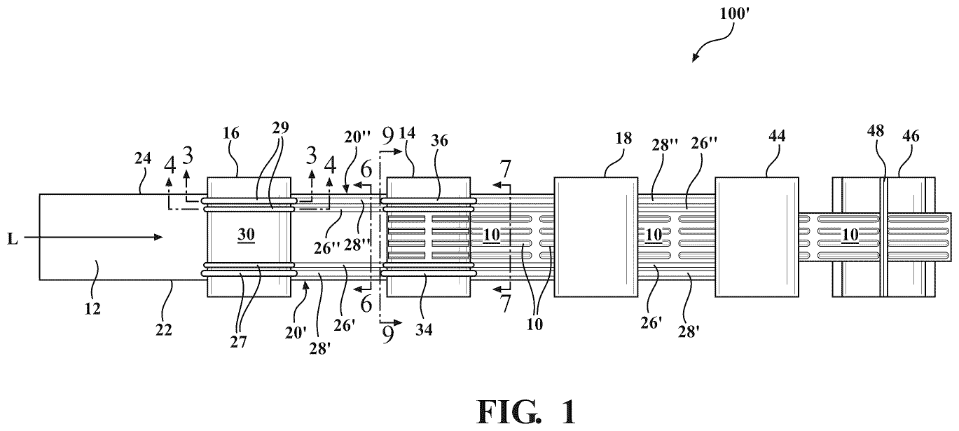

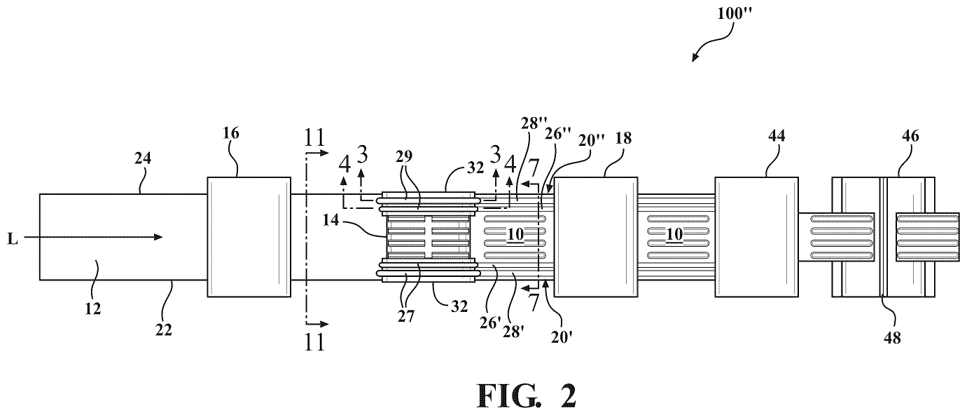

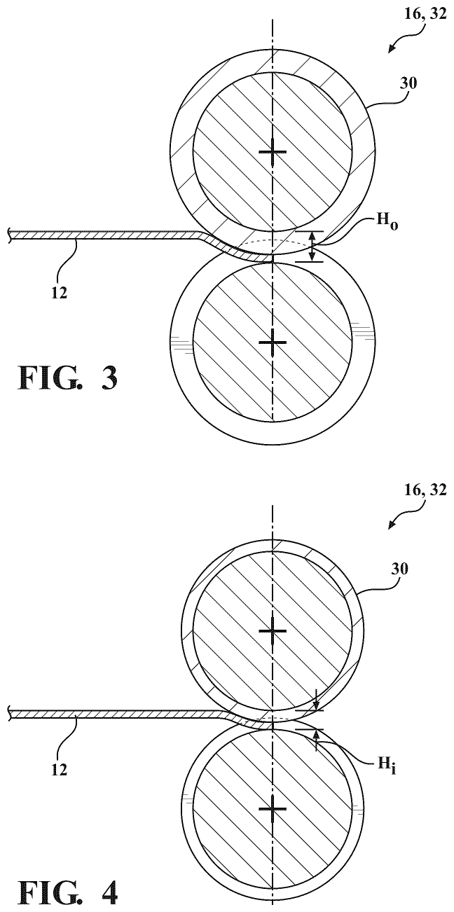

As illustrated in FIG. 7, bipolar plates (“BPP”) 10 for fuel cells are formed to have flow channels 11 on opposite sides, such as for example to allow for the passage of fuel on one side and oxidant or coolant on the other opposing side. The design of these flow channels 11 can vary, such as being linear, coiled, parallel, comb-like, etc. Bipolar plates 10 are typically made from graphite or metal, depending on such factors as chemical compatibility, corrosion resistance, cost, mechanical strength, etc. In the case of the bipolar plates 10 being formed from metal, and as illustrated in FIGS. 1-2, a method of manufacturing 100 includes passing a metal sheet 12 in a longitudinal direction L through a BPP forming roll 14 to form a series of bipolar plates 10 sequentially arranged in the metal sheet 12 each having flow channels 11 patterned on opposing sides (See, e.g., FIG. 7). As best shown in FIG. 7, the BPP forming roll 14 can include a pair of BPP forming rolls 14 which each rotate about an axis A₁ and include corresponding patterns to form the flow channels 11 for the BPP 10 on the metal sheet 12 passing therebetween.

As further illustrated in FIGS. 1-2, the method of manufacturing 100 includes passing the metal sheet 12 through a first tension roll 16 disposed upstream from and prior to the BPP forming roll 14 and a second tension roll 18 disposed downstream from and subsequent to the BPP forming roll 14. The first and second tension rolls 16, 18 collectively apply a longitudinal tension, applied generally along the longitudinal direction L, from both upstream and downstream on the metal sheet 12 as it passes through the BPP forming roll 14 to reduce wrinkling, spring back and bending of the metal sheet 12 during the BPP forming process. However, use of the first and second tension rolls 16, 18 alone is not sufficient to eliminate these manufacturing problems and resultant BPP defects. Accordingly, the subject method of manufacturing 100 includes application of an additional lateral tension to the metal sheet 12 during the BPP forming process itself, the lateral tension applied generally transversely to the longitudinal tension applied by the tension roll 18 and used to constrain lateral movement of the material during forming of the BPP 10. Thus, the subject method of manufacturing 100 results in both longitudinal and lateral tension being applied to the sheet metal 12 while passing through the BPP forming roll 14.

More specifically, the lateral tension applied in the subject method of manufacturing the BPPs 10 includes forming a plurality of first lateral tension features 20′ along a first side 22 of the metal sheet 12 and a plurality of second lateral tension features 20″ along a second side 24 of the metal sheet 12 for use in establishing the lateral tension during the BPP forming process (the lateral tension being applied generally transverse to the longitudinal direction L of the metal sheet). In a preferred arrangement, the plurality of first and second lateral tension features 20′, 20″ each include a respective first and second pair of inner and outer lateral tension features 26′, 26″, 28′, 28″ defined relative to and generally parallel with the longitudinal direction L of the metal sheet 12, in which the outer lateral tension feature 28′, 28″ in each pair has an outer height Hₒ being greater than an inner height Hᵢ of the inner lateral tension feature 26′, 26″. The use of a plurality of first and second lateral tension features 20′, 20″ of varying heights along both sides 22, 24 of the metal sheet 12 provides a more consistent application of lateral tension during the BPP forming process as compared to a single lateral tension feature, which advantageously solves the problems of wrinkling, spring back and bending of the metal sheet 12 during forming of the bipolar plates 10.

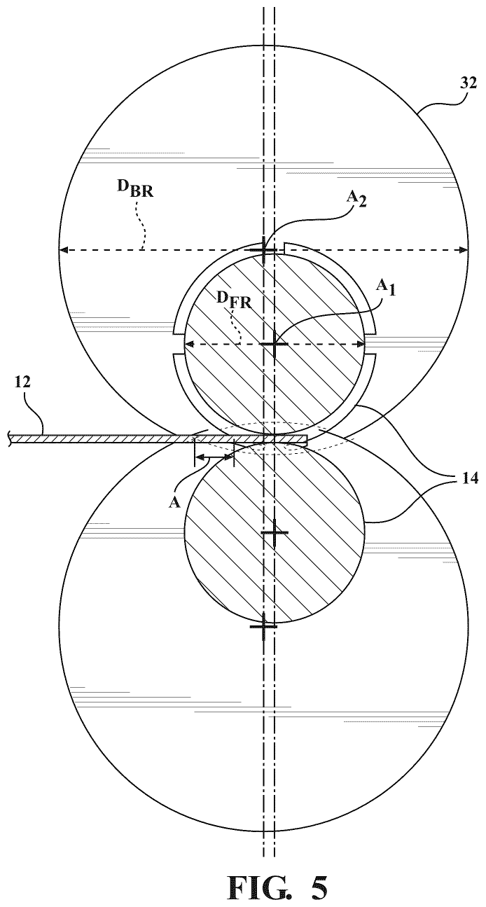

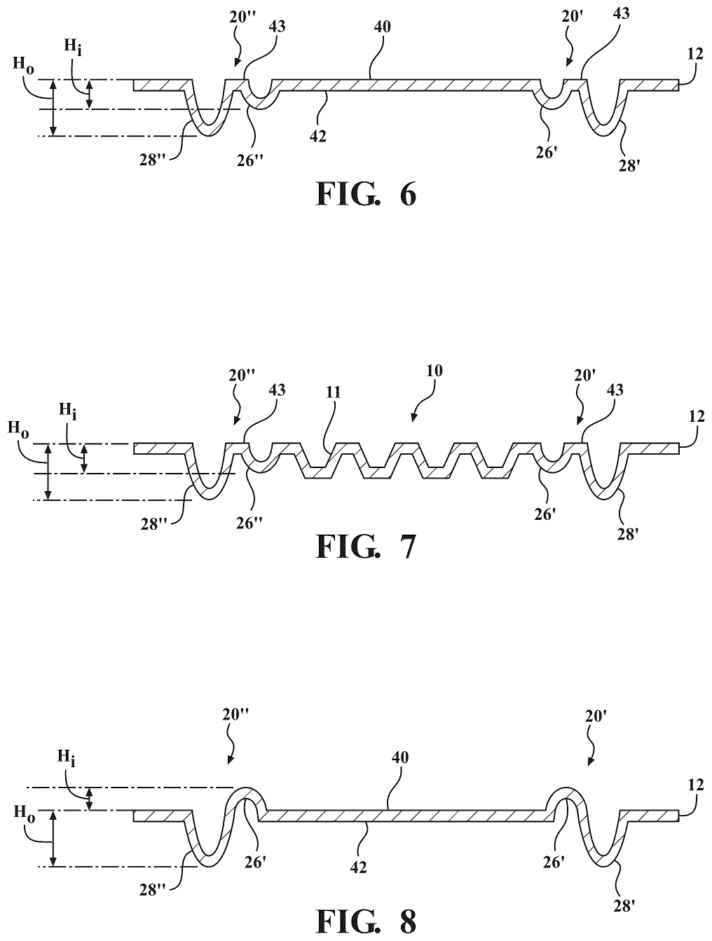

As illustrated in FIG. 1, in accordance with a first arrangement of the manufacturing method 100′, the first and second pair of inner and outer lateral tension features 26′, 26″, 28′, 28″ are formed via a combined bead and tension roll 30 disposed upstream of the BPP forming roll 14 for use in establishing the lateral tension during the BPP forming process in accordance with this first arrangement. More specifically, the combined bead and tension roll 30 which is utilized to establish the longitudinal tension on the metal sheet 12 also includes a first pair of forming features 27 disposed at a first end of the combined bead and tension roll 30 for forming the first pair of inner and outer lateral tension features 26′, 26″ in the metal sheet 12, and a second pair of forming features 29 disposed at a second end of the combined bead and tension roll 30 for forming the second pair of inner and outer lateral tension features 28′, 28″. The first and second forming features 27, 29 are preferably arranged as protrusions extending outwardly from and around a circumferential surface of the combined bead and tension roll 30. However, other means of the first and second forming features 27, 29 could be utilized without departing from the scope of the subject disclosure. As illustrated in FIG. 2, in accordance with a second arrangement of the manufacturing method 100″, the first and second pairs of inner and outer lateral tension features 26′, 26″, 28′, 28″ are formed via a pair of bead rollers 32 each attached to a respective end of the BPP forming roll 14 and having a respective one of the first or second pair of forming features 27, 29. As best illustrated in FIGS. 6-7, in each arrangement, the resultant inner and outer lateral tension features 26′, 26″, 28′, 28″ are preferably shaped as and comprised of beads extending generally parallel to the first and second sides 22, 24 and the longitudinal direction L of the metal sheet 12. However, the inner and outer lateral tension features 26′, 26″, 28′, 28″ could also have other shapes, such as flanges, nips or the like, without departing from the scope of the subject disclosure.

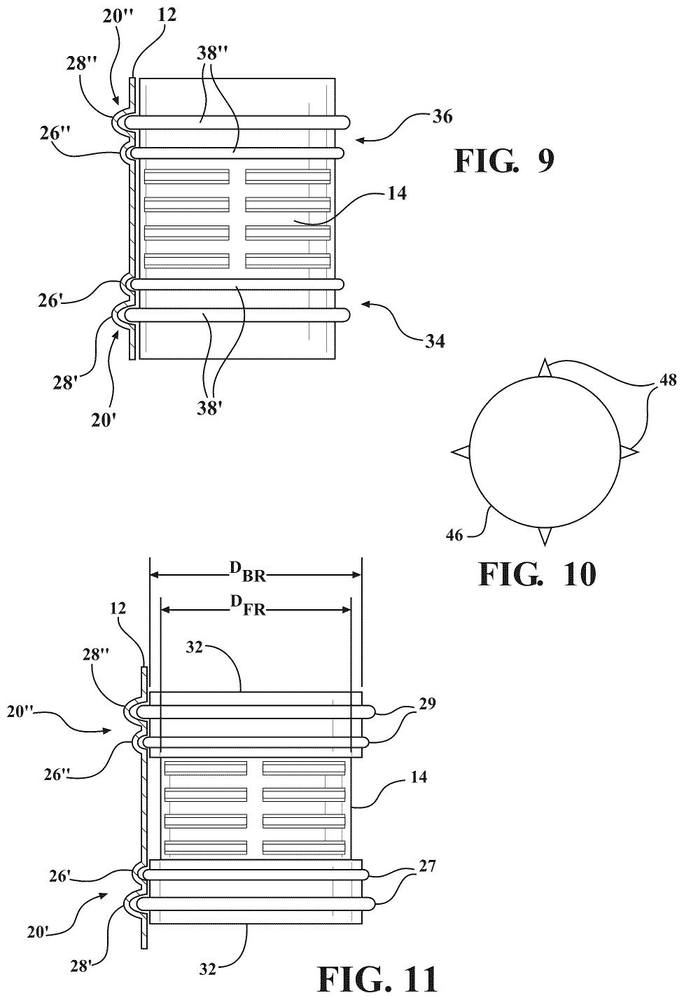

As illustrated in FIG. 1, in accordance with the first arrangement of the manufacturing method 100′, the BPP forming roll 14 can include a first mating feature 34 disposed adjacent the first side 22 of the metal sheet 12 and a second mating feature 36 disposed adjacent the second side 24 of the metal sheet, each for mating with the respective first and second pairs of inner and outer lateral tension features 26′, 26″, 28′, 28″ as the metal sheet 12 passes through the BPP forming roll 14 to establish and apply the lateral tension to the metal sheet 12. For example, as best illustrated in FIG. 9, the first and second mating features 30, 32 on the BPP forming roll 14 can each be comprised of a first and second pair of protrusions 38′, 38″ each for being disposed within a respective pair of the inner and outer lateral features 26′, 26″, 28′, 28″ as the metal sheet 12 passes through the BPP forming roll 14. However, the first and second mating features 30, 32 could each include only a single protrusion for mating with only a respective one of the inner and outer lateral features 26′, 26″, 28′, 28″ if less lateral tension force is required in the manufacturing method. In either arrangement, the inner and outer lateral features 26′, 26″, 28′, 28″ in cooperation with the respective first and second mating features 30, 32 on the BPP forming rollers 14 restrict material flow when the metal sheet 12 passes through the BPP forming roll 14 and collectively create the lateral tension during this forming process. Put another way, the cooperating and respectively mated inner and outer lateral tension features 26′, 26″, 28′, 28″ and the first and second mating features 30, 32 create lateral tension on the metal sheet 12 that is used in the actual BPP forming roll 14 and used to constrain the movement of the material during forming of the BPP 10.

As illustrated in FIG. 2, a separate mating feature is not required in the second arrangement of the manufacturing method 100″ since the pair of bead rollers 32 are disposed on respective ends of the BPP forming roll 14 and their respective forming features 27, 29 provide dual functionality, namely first forming the first and second pairs of inner and outer lateral tension features 26′, 26″, 28′, 28″ and then subsequently providing the mating function/feature to create the lateral tension on the metal sheet since one and the other are achieved almost contemporaneously (i.e., the inner and outer lateral tension forming features 26′, 26″, 28′, 28″ are formed just before forming the BPPs, and thus the first and second forming features 27, 29 stay mated with the inner and outer lateral tension features 26′, 26″, 28′, 28″ right after formation, and during formation of the flow channels 11 for the BPP 10 by the BPP forming roll 14). However, as illustrated in FIG. 5, in this arrangement the pair of bead rollers 32 have a second axis of rotation A₂ that is slightly offset in an upstream direction from a first axis of rotation A₁ of the BPP forming roller 14 such that the first and second pairs of inner and outer lateral tension features 26′, 26″, 28′, 28″ are formed immediately before the forming of the channels 11 in the BPPs 10. Put another way, the formation of the first and second pair of inner and outer lateral features 26′, 26″, 28′, 28″ by the pair of bead rollers 32 occurs along a spacing distance A which ends prior to a start of a formation of flow channels 11 in the metal sheet 12 with the forming roller 14. Additionally, as best shown in FIGS. 5 and 11, the pair of bead rollers 32 have a bead roller diameter D_{BR} being greater than a forming roll diameter D_{FR} of the BPP forming roll 14, to facilitate the plurality of first and second lateral tension features 20′, 20″ being formed before the forming of the channels 11 in the BPP 10. Thus, the use of the separate pair of bead rollers 32 provides control on the timing of the formation of the inner and outer lateral tension features 26′, 26″, 28′, 28″ to make sure they are completed and can remain engaged by the first and second forming features 27, 29 to create lateral tension force before the forming of the channels 11. Additionally, since the pair of bead rollers 32 are separate from the BPP forming roll 14 and can be attached and removed to the respective ends, this provides flexibility to change out a desired geometry of the plurality of lateral tension features 20′, 20″ without really effecting anything on the forming roll 14 and vice versa.

As best illustrated in FIGS. 6-7, each of the first and second pair of inner and outer lateral features 26′, 26″, 28′, 28″ are comprised of beads which all extend from either a top 40 or bottom 42 of the metal sheet 12. In accordance with a first arrangement, all of the first and second pair of inner and outer lateral features 26′, 26″, 28′, 28″ extend from the same surface, i.e., all from the top 40 or all from the bottom 42 (as shown in FIGS. 6-7). However, as illustrated in FIG. 8, in an alternative embodiment the first and second pairs of inner and outer lateral tension features 26′ 26″, 28′, 28″ can extend from an opposing top and bottom 40, 42 of the metal sheet 12 to collectively define a cross-sectional S-shape for each pair of inner and outer lateral features when viewed in cross-section along a plane transverse to the longitudinal direction L. For example, as shown in FIG. 8, the inner lateral features 26′, 26″ can extend from the top 40 of the metal sheet 12 and the outer lateral features 28′, 28″ can extend from the bottom 42 of the metal sheet to establish an inverted shape for each pair of inner and outer lateral features 26′, 26″, 28′, 28″. In this alternative embodiment, the inverted arrangement of the inner and outer lateral features 26′, 26″, 28′, 28″ also leads to material savings because the spacing area 43 extending between the inner and outer lateral features 26′, 26″, 28′, 28″ in the first arrangement (See FIGS. 6-7) can be reduced or entirely removed, providing an option to reduce an overall width of the metal sheet 12 if needed.

As illustrated in FIGS. 1-2, in any arrangement, the method of manufacturing 100 includes passing the metal sheet 12 with a plurality of formed BPPs 10 through an edge sheer roll 44 disposed downstream of the BPP forming roll 14 and the second tension roll 18 (if present) for removing the plurality of first and second lateral tension features 20′, 20″ from the metal sheet 12. In a preferred arrangement, the edge sheer roll 44 utilizes laser cutting to remove the plurality of first and second lateral tension features 20′, 20″. However, other means of sheering off the plurality of lateral tension features 20′, 20″ from the first and second sides 22, 24 of the metal sheet 12 can be utilized without departing from the scope of the subject disclosure.

After passing through the edge shear roll 44, the method of manufacturing 100 continues by passing the metal sheet 12 with the removed lateral tension features 20′, 20″ through a roll cutter 46 to cut the metal sheet 12 into the individually formed BPPs 10. The roll cutter 46 can include a roller with cutting edges 48 (as best shown in FIG. 10) or a laser cutting mechanism, to individually cut and remove the BPPs 10 from the metal sheet 12. However, other means of roll cutting could be utilized without departing from the scope of the subject disclosure.

Obviously, many modifications and variations of the present disclosure are possible in light of the above teachings and may be practiced otherwise than as specifically described.

What is claimed is:

1. A method of manufacturing bipolar plates comprising:
passing a metal sheet in a longitudinal direction L through a bipolar plate (BPP) forming roll to form a series of bipolar plates sequentially arranged in the metal sheet;
passing the metal sheet through at least one tension roller disposed either upstream or downstream to the BPP forming roll to establish a longitudinal tension on the metal sheet as it passes through the BPP forming roll;
forming a first pair of inner and outer lateral tension features along a first side of the metal sheet and a second pair of inner and outer later tension features along a second side of the metal sheet, wherein one of the outer or inner lateral tension features in each of the first and second pairs having a respective outer or inner height Hₒ, Hᵢ being greater than an outer or inner height Hₒ, Hᵢ of the other outer or inner later tension feature in each of the first and second pairs; and
mating a first mating feature and a second mating feature each arranged on the BPP forming roll with a respective one of the first and second pairs of inner and outer lateral tension features as the metal sheet passes through the BPP forming roll to establish a lateral tension on the metal sheet applied generally transverse to the longitudinal direction.

2. The method or manufacturing bipolar plates as set forth in claim 1, wherein the outer lateral tension feature in each of the first and second pairs has an outer height Hₒ being greater than an inner height Hᵢ of the inner later tension feature.

3. The method of manufacturing bipolar plates as set forth in claim 1, wherein the inner and outer lateral tension features in each of the first and second pairs are comprised of beads extending from a top or a bottom of the metal sheet.

4. The method of manufacturing bipolar plates as set forth in claim 3, wherein the inner and outer lateral tension features in both of the first and second pairs all extend from either the top or the bottom of the metal sheet.

5. The method of manufacturing bipolar plates as set forth in claim 3, wherein the inner and outer lateral tension features in both of the first and second pairs extend from an opposing top and bottom of the metal sheet to collectively establish an inverted cross-sectional S-shape for each pair of inner and outer lateral tension features.

6. The method of manufacturing bipolar plates as set forth in claim 1, wherein the step of passing the metal sheet through at least one tension roller includes passing the metal sheet through a first tension roll disposed upstream from and prior to the BPP forming roll.

7. The method of manufacturing bipolar plates as set forth in claim 6, wherein the step of passing the metal sheet though at least one tension roller additionally includes passing the metal sheet through a second tension roll disposed downstream from and subsequent to the BPP forming roll to collectively apply the longitudinal tension to the metal sheet from both upstream and downstream as the metal sheet passes through the BPP forming roll.

8. The method of manufacturing bipolar plates as set forth in claim 6, wherein the first tension roll is a combined bead and tension roll, and wherein the step of forming the first and second pairs of inner and outer lateral tension features includes forming the first and second pairs of inner and outer lateral tension features by the combined bead and tension roll as the metal sheet passes therethrough.

9. The method of manufacturing bipolar plates as set forth in claim 6, wherein the step of forming the first and second pairs of inner and outer lateral tension features includes forming the first and second pairs of inner and outer lateral tension features via a pair of bead rollers each attached to a respective end of the BPP forming roll.

10. The method of manufacturing bipolar plates as set forth in claim 9, wherein an axis of rotation A₂ of the pair of bead rollers is arranged slightly offset and in an upstream direction from an axis of rotation A₁ of the BPP forming roller such that the plurality of first and second lateral tension features are formed by the pair of bead rollers immediately before flow channels for the series of bipolar plates are formed in the metal sheet by the BPP forming roll.

11. The method of manufacturing bipolar plates as set forth in claim 10, wherein the pair of bead rollers each have a bead roller diameter D_{BR} being greater than a forming roll diameter D_{FR} of the BPP forming roll.

12. The method of manufacturing bipolar plates as set forth in claim 1, wherein the first mating feature is comprised of a first pair of protrusions disposed on the BPP forming roll and the second mating feature is comprised of a second pair of protrusions disposed on the BPP forming roll, and wherein the step of mating the first mating feature and the second mating feature includes mating the first pair of protrusions with the first pair of inner and outer lateral tension features and mating the second pair of protrusions with the second pair of inner and outer features as the metal sheet passes through the BPP forming roll to establish the lateral tension on the metal sheet.

13. The method of manufacturing bipolar plates as set forth in claim 1, further comprising passing the metal sheet with the formed series of BPPs and first and second pairs of inner and outer lateral tension features through an edge sheer roll disposed downstream from BPP forming roll to remove the first and second inner and outer lateral tension features from the metal sheet.

14. The method of manufacturing bipolar plates as set forth in claim 13, wherein the edge sheer roll includes laser cutting for removing the first and second inner and outer lateral tension features.

15. The method of manufacturing bipolar plates as set forth in claim 13, further comprising passing the metal sheet with the removed first and second inner and outer lateral tension features through a roll cutter disposed downstream from the edge sheer roll to cut the metal sheet into individually formed BPPs.

16. The method of manufacturing bipolar plates as set forth in claim 15, wherein the roll cutter is comprised or a roller with cutting edges or a laser cutting mechanism.
